(19) United States
(12) Patent Application Publication
(10) Pub. No.: US 2026/0346913 A1
(43) Pub. Date: Nov. 5, 2026

(54) VEHICLE SYSTEMS INCLUDING AUTOMATED COUNTER-STEER ADJUSTMENT FOR STEER-BY-WIRE CONTROL

(71) Applicant: GM GLOBAL TECHNOLOGY OPERATION LLC, Detroit, MI (US)

(72) Inventors: Gabriel de PAULA EDUARDO, Brighton, MI (US); Michael C. GAUNT, Metamora, MI (US)

(21) Appl. No.: 19/181,495

(22) Filed: Apr. 17, 2025

(51) Int. Cl. B62D 6/00

(52) U.S. Cl. CPC B62D 6/005

(57) ABSTRACT

An example vehicle system includes a steering wheel configured to rotate less than or equal to 150 degrees in each direction, a steer-by-wire link between the steering wheel and front wheels of the vehicle, a steering wheel position sensor configured to detect a steering wheel angle, and an inertia measurement unit configured to detect a lateral acceleration and yaw rate of the vehicle. A vehicle control module is configured to identify a counter-steer condition based on the steering wheel angle, the lateral acceleration and the yaw rate, the counter-steer condition indicative of the steering wheel angle having an opposite polarity to the yaw rate, determine a counter-steer amplification gain based on the lateral acceleration and the yaw rate, and apply the counter-steer amplification gain to the steer-by-wire link to increase the wheel angle of the front wheels relative to the steering wheel angle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle systems including automated counter-steer adjustment for steer-by-wire control.

Vehicles are equipped with steering mechanisms including a steering wheel which may be mechanically connected to wheels of the vehicle. Many steering mechanisms include a steering shaft, column, or other mechanical structure to couple or otherwise provide steering movement between the steering wheel and the wheels.

Some vehicles may be equipped with a steer-by-wire system, which provides steering between the steering wheel and the wheels without the use of a steering column. Steer-by-wire removes mechanical connections and utilizes a relationship between the steering wheel and the wheels, such that the wheels are responsive to a degree of movement of the steering wheel.

### SUMMARY

An example vehicle system including automated counter-steer adjustment for steer-by-wire control includes front wheels of a vehicle, a steering wheel configured to rotate less than or equal to 150 degrees in each direction from a neutral steering wheel position, a steer-by-wire link between the steering wheel and the front wheels of the vehicle, the steer-by-wire link configured to adjust a wheel angle of the front wheels in response to rotation of the steering wheel, a steering wheel position sensor configured to detect a steering wheel angle of the steering wheel, an inertia measurement unit configured to detect a lateral acceleration of the vehicle and a yaw rate of the vehicle, and a vehicle control module configured to obtain the steering wheel angle of the steering wheel, the lateral acceleration of the vehicle, and the yaw rate of the vehicle, identify a counter-steer condition based on the steering wheel angle, the lateral acceleration and the yaw rate, wherein the counter-steer condition is indicative of the steering wheel angle having an opposite polarity to the yaw rate, in response to identifying the counter-steer condition, determine a counter-steer amplification gain based on the lateral acceleration and the yaw rate, and applying the counter-steer amplification gain to the steer-by-wire link to increase the wheel angle of the front wheels relative to the steering wheel angle.

In some examples, the steering wheel comprises a yoke steering wheel having hand grip portions at three o'clock and nine o'clock positions relative to a center of the yoke steering wheel.

In some examples, the yoke steering wheel does not include hand grip positions at twelve o'clock and six o'clock positions relative to the center of the yoke steering wheel.

In some examples, the vehicle control module is configured to determine the counter-steer amplification gain by applying a first saturation function to the lateral acceleration to generate a lateral acceleration trigger, applying a second saturation function to the yaw rate to generate a yaw rate trigger, and determining the counter-steer amplification gain according to the lateral acceleration trigger and the yaw rate trigger.

In some examples, the vehicle control module is configured to determine the counter-steer amplification gain by combining the lateral acceleration trigger and the yaw rate trigger, and scaling a combination of the lateral acceleration trigger and the yaw rate trigger using a lookup table to determine the counter-steer amplification gain.

In some examples, the vehicle control module is configured to obtain the wheel angle of the front wheels, and process the wheel angle of the front wheels using a road wheel angle lookup table to determine a road wheel angle gain.

In some examples, the vehicle control module is configured to combine the counter-steer amplification gain and the road wheel angle gain to generate a road wheel angle overlay, and increase the wheel angle of the front wheels relative to the steering wheel angle, according to the road wheel angle overlay, to facilitate increased counter-steer of the front wheels of the vehicle.

In some examples, the vehicle control module is configured to access a reference model tuned to predict vehicle parameters for a baseline driving condition, obtain current vehicle parameters according to a current driving condition of the vehicle, compare the current vehicle parameters to the reference model, and identify the counter-steer condition according to a difference between the current vehicle parameters and the reference model exceeding a specified counter-steer threshold.

In some examples, the vehicle control module is configured to determine an error overlay based on the difference between the current vehicle parameters and the reference model, and adjust the steering wheel angle according to the error overlay. In some examples, the inertia measurement unit includes at least one of an accelerometer or a gyroscope.

An example method of automatically adjusting counter-steer for steer-by-wire control of a vehicle includes obtaining, from a steering wheel position sensor, a steering wheel angle of a steering wheel of the vehicle, wherein the steering wheel is configured to rotate less than or equal to 150 degrees in each direction from a neutral steering wheel position, obtaining a lateral acceleration of the vehicle, and a yaw rate of the vehicle, from an inertia measurement unit, identifying a counter-steer condition based on the steering wheel angle, the lateral acceleration and the yaw rate, wherein the counter-steer condition is indicative of the steering wheel angle having an opposite polarity to the yaw rate, in response to identifying the counter-steer condition, determining a counter-steer amplification gain based on the lateral acceleration and the yaw rate, and applying the counter-steer amplification gain to a steer-by-wire link to increase a wheel angle of front wheels of the vehicle relative to the steering wheel angle, wherein the steer-by-wire link is configured to adjust the wheel angle of the front wheels in response to rotation of the steering wheel.

In some examples, the steering wheel comprises a yoke steering wheel having hand grip portions at three o'clock and nine o'clock positions relative to a center of the yoke steering wheel.

In some examples, the yoke steering wheel does not include hand grip positions at twelve o'clock and six o'clock positions relative to the center of the yoke steering wheel.

In some examples, determining the counter-steer amplification gain includes applying a first saturation function to the lateral acceleration to generate a lateral acceleration trigger, applying a second saturation function to the yaw rate to generate a yaw rate trigger, and determining the counter-steer amplification gain according to the lateral acceleration trigger and the yaw rate trigger.

In some examples, determining the counter-steer amplification gain includes combining the lateral acceleration trigger and the yaw rate trigger, and scaling a combination of the lateral acceleration trigger and the yaw rate trigger using a lookup table to determine the counter-steer amplification gain.

In some examples, the method includes obtaining the wheel angle of the front wheels, and processing the wheel angle of the front wheels using a road wheel angle lookup table to determine a road wheel angle gain.

In some examples, the method includes combining the counter-steer amplification gain and the road wheel angle gain to generate a road wheel angle overlay, and increasing the wheel angle of the front wheels relative to the steering wheel angle, according to the road wheel angle overlay, to facilitate increased counter-steer of the front wheels of the vehicle.

In some examples, the method includes accessing a reference model tuned to predict vehicle parameters for a baseline driving condition, obtaining current vehicle parameters according to a current driving condition of the vehicle, comparing the current vehicle parameters to the reference model, and identifying the counter-steer condition according to a difference between the current vehicle parameters and the reference model exceeding a specified counter-steer threshold.

In some examples, the method includes determining an error overlay based on the difference between the current vehicle parameters and the reference model, and adjusting the steering wheel angle according to the error overlay.

An example vehicle system including automated counter-steer adjustment for steer-by-wire control includes front wheels of a vehicle, a yoke steering wheel configured to rotate less than or equal to 150 degrees in each direction from a neutral steering wheel position, a steer-by-wire link between the yoke steering wheel and the front wheels of the vehicle, the steer-by-wire link configured to adjust a wheel angle of the front wheels in response to rotation of the yoke steering wheel, and a vehicle control module configured to obtain a steering wheel angle of the yoke steering wheel, a lateral acceleration of the vehicle, and a yaw rate of the vehicle, from one or more vehicle sensors, identify a counter-steer condition based on the steering wheel angle, the lateral acceleration and the yaw rate, wherein the counter-steer condition is indicative of the steering wheel angle having an opposite polarity to the yaw rate, in response to identifying the counter-steer condition, determine a counter-steer amplification gain based on the lateral acceleration and the yaw rate, and apply the counter-steer amplification gain to the steer-by-wire link to increase the wheel angle of the front wheels relative to the steering wheel angle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example vehicle including a vehicle control module configured to provide automated counter-steer adjustment for steer-by-wire control according to the present disclosure;

FIG. 2 is a partial perspective view of an example interior of a vehicle equipped with a steer-by-wire system according to the present disclosure;

FIG. 3 is a is an example block diagram of a vehicle a steer-by-wire system according to the present disclosure;

FIG. 4 is a front view of an example yoke steering wheel according to the present disclosure;

FIG. 5 is a flowchart depicting an example process for automated counter-steer adjustment for steer-by-wire control according to the present disclosure;

FIG. 6 is a flowchart depicting an example process for determining yaw rate trigger signals and lateral acceleration trigger signals according to the present disclosure;

FIG. 7 is a flowchart depicting an example process for determining a road wheel angle value according to the present disclosure;

FIG. 8 is a flowchart depicting an example process for activating counter-steer detection triggers according to the present disclosure; and

FIG. 9 is a flowchart depicting an example process for applying counter-steer amplification gain values according to the present disclosure.

In the drawings, reference numbers may be reused to identify similar and/or identical elements.

### DETAILED DESCRIPTION

Some example embodiments described herein enable yoke steering wheel designs (or other rotation limited steering wheels) to use a full road wheel angle with reduced steering input, such as where the yoke steering wheel is limited to 150 degrees or less of steering rotation input. For example, with a yoke steering wheel a driver may hold the wheel at three o'clock and nine o'clock positions, where the yoke steering wheel does not include any hand grip portions at twelve o'clock and six o'clock positions. Yoke steering wheels may use a limited rotation range compared to other steering wheel types, because it would be difficult for a driver to relocate their hands on the wheel to rotate the yoke steering wheel more than, e.g., 150 degrees in either direction from a neutral steering wheel position.

A limited range of steering wheel rotation may limit the range of directly corresponding changes in road wheel angle. However, in some example embodiments, a steer-by-wire control system may increase the amount of road wheel angle change corresponding to steering wheel rotation, to provide sharper road wheel steering angles with less steering wheel rotation during some detected driving conditions. For example, it may be useful to add additional road wheel angle change based on reduced steering wheel rotation input during some driving maneuvers, such as using counter-steer to recover from an oversteering loss of control of the vehicle. This may allow a yoke steering wheel (or other steering wheel with limited rotation range) to still provide a sufficient amount of road wheel angle change during certain driving conditions, compared to other steering wheel types which allow greater ranges of steering wheel rotation.

In some examples, a vehicle control module receives the steering wheel angle, vehicle lateral acceleration and vehicle yaw rate signals, which are processed based on individual signal thresholds to extract the polarity of each signal. The polarity of each signal is then compared in pairs to identify opposing directions. The processed signals may be supplied to a saturation function (which may include one or more thresholds) to generate lateral acceleration and yaw rate triggers indicative of whether or not a counter-steer condition has been detected based on the signals. The lateral acceleration and yaw rate triggers are then combined and scaled (e.g., by a lookup table) to generate a counter-steer amplification gain.

The current road wheel angle may be processed using a lookup table, to provide a road wheel angle gain value. The road wheel angle gain value may then be combined with the counter steer amplification gain to obtain a road wheel angle overlay value, which may be used to increase a change in road wheel angle based on steering wheel rotation input.

Some example embodiments described herein enable enhanced use of a yoke steering wheel design, by amplifying the driver counter-steer inputs on a steer-by-wire vehicle during an oversteer recovery. The amplified counter-steer inputs enable an increased or full range of road wheel angle change, based on limited steering wheel input such as a maximum steering wheel rotation of around 150 degrees in either direction from a neutral steering wheel position. A steering control module may detect counter steer using the steering wheel angle, vehicle yaw rate and vehicle lateral acceleration signals, and output a combined trigger signal to enable the counter-steer amplification. The steering control module may automatically scale the detected driver counter-steer input based on a detected counter-steer condition, to fully utilize the road wheel angle based on a limited steering input angle of up to 150 degrees (or more or less).

Some example steer-by-wire systems may be configured to receive various vehicle input parameters as sensed by vehicle sensors or calculated by a vehicle control module or processors, including but not limited to a vehicle speed, a steering wheel angle, a steering wheel velocity, vehicle lateral acceleration, vehicle longitudinal acceleration, vehicle yaw rate, road surface friction, steering wheel torque, road wheel angle, etc. The vehicle control module may be configured to calculate a counter-steer trigger signal for detecting oversteer recovery (e.g., a driver counter-steer input to the steering wheel) by processing the steering wheel angle, vehicle lateral acceleration and vehicle yaw rate signals, by comparing each signal to individual thresholds to extract the polarity.

In some examples, during an oversteer recovery, deleted counter-steer input to a yoke steering wheel provides additional road wheel angle changes. This allows the driver to use an increased or full range of full road wheel angle change, while using reduced/limited steering wheel angle input, such as in the case of a yoke steering wheel design where the driver holds three o'clock and nine o'clock positions (e.g., limited to 150 degrees of rotation or less due to the structure of the yoke steering wheel).

Some example embodiments may provide one or more benefits, such as enabling enhanced performance for a yoke steering wheel design, where the driver holds three o'clock and nine o'clock positions and uses a reduced rotation range of steering input, during an oversteer recovery counter-steer operation. That allows improved oversteer recovery compared to implementations where the road wheel angle directly corresponds to a steering wheel angle input which is limited to only 150 degrees for example. Example steering control modules may facilitate detection of a driver counter-steer condition, and use increased or full road wheel angle travel based on reduced driver steering wheel angle input. This approach may be used with yoke steering wheels, round steering wheels with limited (e.g., 150 degrees or less) rotation, etc. Example vehicle control modules may use steer-by-wire steering systems.

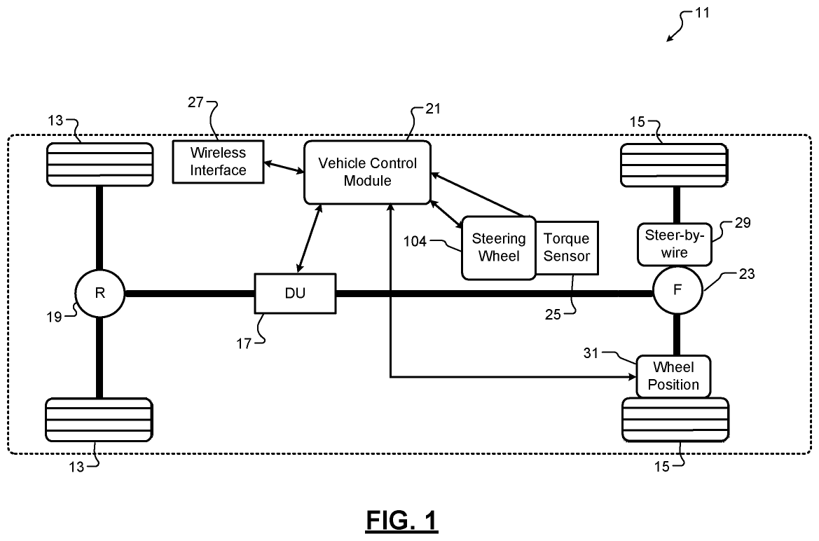

Referring now to FIG. 1, a vehicle 11 includes front wheels 15 and rear wheels 13. In FIG. 1, a drive unit 17 selectively outputs torque to the front wheels 15 and/or the rear wheels 13 via drive lines 23, 19, respectively. The vehicle 11 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 17 may include any suitable electric motor, a power inverter, and a motor controller configured to control power switches within the power inverter to adjust the motor speed and torque during propulsion and/or regeneration. A battery system provides power to or receives power from the electric motor of the drive unit 17 via the power inverter during propulsion or regeneration.

While the vehicle 11 includes one drive unit 17 in FIG. 1, the vehicle 11 may have other configurations. For example, two separate drive units may drive the front wheels 15 and the rear wheels 13, one or more individual drive units may drive individual wheels, etc. As can be appreciated, other vehicle configurations and/or drive units can be used.

The vehicle control module 21 may be configured to control operation of one or more vehicle components, such as the drive unit 17 (e.g., by commanding torque settings of an electric motor of the drive unit 17). The vehicle control module 21 may receive inputs for controlling components of the vehicle, such as signals received from a steering wheel 104, an acceleration pedal, a brake pedal, a wheel position sensor 31, a torque sensor 25 connected to the steering wheel 104, a steer-by-wire link 29, an inertia measurement unit (IMU), etc. The vehicle control module 21 may monitor telematics of the vehicle for safety purposes, such as vehicle speed, vehicle location, vehicle braking and acceleration, etc.

The vehicle control module 21 may receive signals from any suitable components for monitoring one or more aspects of the vehicle, including one or more vehicle sensors (such as steering linkage torque sensors, cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current net torque applied to a steering linkage (e.g., a torsion bar) of the vehicle, current lateral acceleration of the vehicle, current yaw rate of the vehicle, current steering wheel position and angle, current road wheel position and angle, etc.

In some examples, the vehicle one or more optional cameras. Each camera may include any suitable camera hardware components, image processing capabilities, etc., to capture images of surroundings of the vehicle, such as road features, other vehicles, etc. In some examples, images from vehicle cameras may be used for object detection, automated driving, lane determination, etc. Other systems such as Lidar may be used to determine images or information about the surrounding environment of the vehicle.

The vehicle 11 includes a steering wheel 104, which is configured to control a steering orientation of the front wheels 15 based on driver input, such as rotating the steering wheel 104. As described further below, a steer-by-wire link 29 may be connected between the steering wheel 104 and the front wheels 15, to control an angle of the front wheels 15 based on a steering angle and/or rotation of the steering wheel 104.

The vehicle control module 21 may communicate with another device via a wireless communication interface 27, which may include one or more wireless antennas for transmitting and/or receiving wireless communication signals. For example, the wireless communication interface 27 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 27 may communicate with a remote computing device over one or more wireless and/or wired networks. Regarding the vehicle-to-vehicle (V2X) communication, the vehicle 11 may include one or more V2X transceivers (e.g., V2X signal transmission and/or reception antennas).

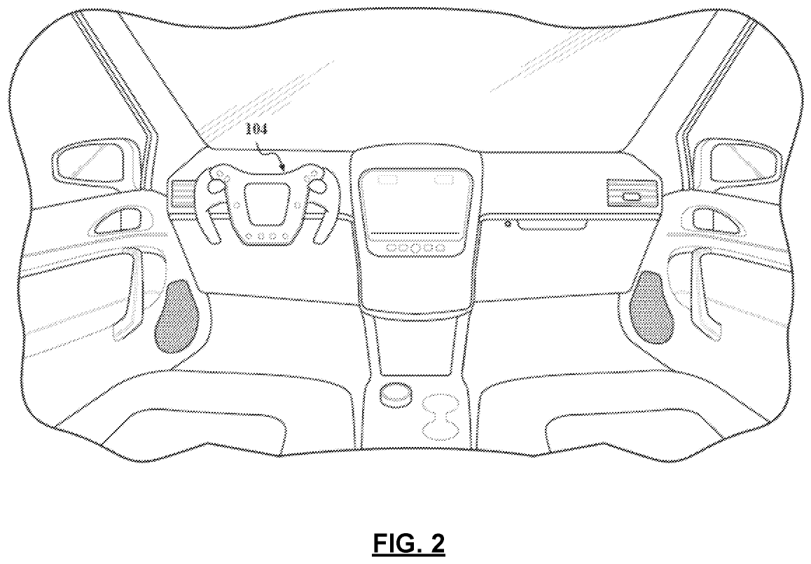

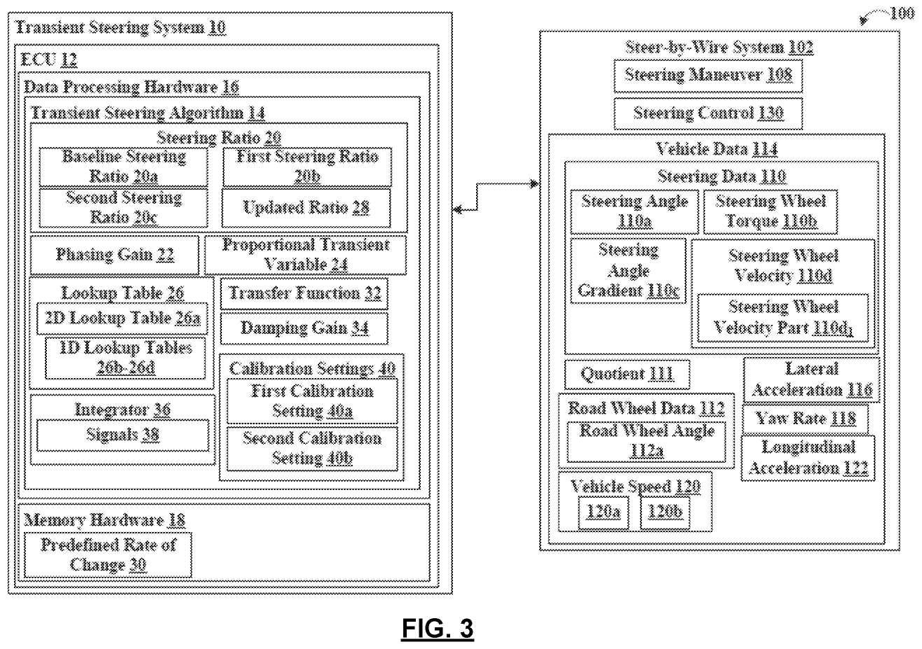

As shown in FIGS. 2 and 3, the vehicle 11 is equipped with a steer-by-wire system 102 configured with a transient steering system 10. The steer-by-wire system 102 includes a steering wheel 104 and road wheels of the vehicle 100 (e.g., the front wheels 15 and rear wheels 13 of FIG. 1). The steering wheel 104 is communicatively and operably coupled to each of the front wheels 15 via the steer-by-wire system 102 to execute a steering maneuver 108 of the vehicle 100. The steering wheel 104 may be configured as a rounded or circular steering wheel, may be configured as a yoke steering wheel, etc.

The steer-by-wire system 102 may be configured to capture steering data 110 associated with the steering wheel 104 and road wheel data 112 associated with the front wheels 15 and/or rear wheels 13. The steer-by-wire system 102 is also configured to communicate the steering data 110 and the road wheel data 112 with the transient steering system 10.

The steering data 110 and the road wheel data 112 may be included as part of vehicle data 114 provided from the steer-by-wire system 102 to the transient steering system 10. The vehicle data 114 may also include, but is not limited to, lateral acceleration 116, a yaw rate 118, and a vehicle speed 120. The steering data 110 may include, but is not limited to, a steering angle 110a and steering wheel torque 110b.

The transient steering system 10 may include an electronic control unit (ECU) 12 configured with a transient steering module 14. The transient steering module 14 receives the steering data 110 and the road wheel data 112. The ECU 12 includes data processing hardware 16 that is configured to execute the transient steering module 14 and memory hardware 18 in communication with the data processing hardware 16. The memory hardware 18 stores instructions that, when executed on the data processing hardware 16, cause the data processing hardware 16 to perform operations, described herein. The transient steering module 14 is configured with a steering ratio 20 associated with the steer-by-wire system 102. For example, the transient steering module 14 may be initially calibrated with a baseline steering ratio 20a.

The baseline steering ratio 20a may also be established after a predetermined duration of operative time of the vehicle 100. The steering ratio 20 reflects the effect of the steering angle 110a on a road wheel angle 112a. For example, the greater the steering ratio 20 the less of an effect the steering angle 110a will have on the road wheel angle 112a. In other words, an operator may manipulate the steering wheel 104 to a greater steering angle 110a in order to result in a desired change in the road wheel angle 112a when the steering ratio 20 is high.

Comparatively, a lower or lesser steering ratio 20 may provide the operator with the ability to make minor changes to the steering angle 110a to effectuate a greater change in the road wheel angle 112a. Thus, the road wheels 106 may have an increased responsiveness to the steering wheel 104 when the steering ratio 20 is small and may have a decreased responsiveness to the steering wheel when the steering ratio 20 is large. The steering ratio 20 may be influenced by the other vehicle data 114, in addition to the steering angle 110a and the road wheel angle 112a, including, but not limited to, the lateral acceleration 116, the yaw rate 118, and the vehicle speed 120 at an initial measurement.

As mentioned above, the steering ratio 20 may include the baseline steering ratio 20a, which represents an initial steering ratio 20a that may be configured as part of the steer-by-wire system 102. For example, the baseline steering ratio 20a may be predetermined based on average vehicle data 114 stored in a server or may be calculated after a predetermined duration of initial operative time of the vehicle 100.

The baseline steering ratio 20a is designed to be a starting point from which the transient steering system 10 can adjust the effect of movement of the steering wheel 104 on the front wheels 15. The transient steering system 10 may communicate changes to the steering ratio 20 (e.g., adjustment of the baseline steering ratio 20a) with the steer-by-wire system 102, and the steer-by-wire system 102 may implement changes to the steering ratio 20 at the steering wheel 104 front wheels 15.

In some examples, the transient steering module 14 is configured to set and adjust the steering ratio 20 in response to the vehicle data 114, as mentioned above, after the baseline steering ratio 20a has been calibrated. During operation of the vehicle 100, the transient steering module 14 may receive a first set 114a of the vehicle data 114 from the steer-by-wire system 102. The first set 114a of the vehicle data 114 may be captured during a predetermined period of operation of the vehicle 100.

For example, the first set 114a may reflect changes to one or more of the lateral acceleration 116, the yaw rate 118, and the vehicle speed 120. Based on the first set 114a of the vehicle data 114, the transient steering module 14 may adjust or otherwise alter the steering ratio 20 to generate a first steering ratio 20b, which is different from the baseline steering ratio 20a.

For example, the transient steering module 14 may manipulate the baseline steering ratio 20a based on a steering angle gradient 110c of the steering data 110. The steering angle gradient 110c is calculated by the transient steering module 14 based on the vehicle speed 120 and the steering angle 110a and reflects a steering wheel velocity 110d.

The transient steering module 14 may then determine the phasing gain 22 based on a proportional transient variable 24 as well as the lateral acceleration 116 and longitudinal acceleration 122 of the vehicle data 114. The proportional transient variable 24 may be stored in a lookup table 26, which may be stored in the memory hardware 18. The lookup table 26 may include a two-dimensional lookup table 26a and various one-dimensional lookup tables 26b-d. The lookup table 26 may be tunable relative to the steering angle gradient 110c and the vehicle speed 120.

The transient steering module 14 may communicate the first steering ratio 20b with the steer-by-wire system 102, and the steer-by-wire system 102 adjusts a steering control 130 based on the first steering ratio 20b. As noted above, the first steering ratio 20b may be different from the baseline steering ratio 20a. The first steering ratio 20b and the second steering ratio 20c may be defined by a quotient 111 between the steering angle 110a and the road wheel angle 112a.

In some examples, the steer-by-wire system 102 continues to collect and monitor the vehicle data 114 during operation of the vehicle 100 and continually sends the vehicle data 114 to the transient steering system 10 for assessment. For example, the transient steering system 10 may receive a second set 114b of the vehicle data 114 from the steer-by-wire system 102 after having adjusted the steering ratio 20 in response to the first set 114a of the vehicle data 114. The second set 114b of the vehicle data 114 may be different from the first set 114a of the vehicle data 114, such that the transient steering module 14 may generate a second steering ratio 20c.

The transient steering module 14 may define an updated ratio 28 between the first steering ratio 20b, the second steering ratio 20c, and the road wheel angle 112a. The steer-by-wire system 102 receives the second steering ratio 20 c from the transient steering system 10 and adjusts the steering control 130 based on the second steering ratio 20c. In some instances, the transient steering module 14 may be configured with a predefined rate of change 30 associated with the second steering ratio 20c.

In some examples, the transient steering module 14 may utilize the lateral acceleration 116 to define the steering angle 110a. The lateral acceleration 116 may change from the first set 114a of the vehicle data 114 to the second set 114b of the vehicle data 114 indicating to the transient steering module 14 that the steering ratio 20 should be adjusted. For example, the vehicle 100 may enter a turn or curve that corresponds to a high G-force event. The transient steering module 14 may compare the second set 114b to the first set 114a of the vehicle data 114 to generate the second steering ratio 20c. In this example, the second steering ratio 20c may be greater than the first steering ratio 20b to reduce the effect of the steering angle 110a on the road wheel angle 112a.

In another example, the transient steering module 14 may utilize the vehicle speed 120 to define the steering ratio 20. For example, the transient steering module 14 may initially receive the first set 114a of vehicle data 114 including a first rate of speed 120a and subsequently receive the second set 114b of vehicle data 114 including a second rate of speed 120b that is different from the first rate of speed 120a.

The transient steering module 14 may be configured to assess the difference between the first rate of speed 120a and the second rate of speed 120b to determine how to adjust the steering ratio 20. For example, if there is a large drop in the vehicle speed 120 from the first rate of speed 120a to the second rate of speed 120b, then the steering ratio 20 may be increased to limit the effect of the steering angle 110a on the road wheel angle 112a. In this example, the increased steering ratio 20 results in large movements or adjustments of the steering wheel 104 effecting minor movements or adjustments at the front wheels 15.

In some examples, the predefined rate of change 30 may be stored in the memory hardware 18 and may be defined relative to the vehicle speed 120. For example, the predefined rate of change 30 is a defined threshold of change in the vehicle speed 120 at which the transient steering module 14 is triggered to increase or decrease the steering ratio 20 (i.e., alter the steering ratio 20 from the first steering ratio 20b to the second steering ratio 20c). Thus, when the transient steering module 14 receives the second set 114b of vehicle data 114, the transient steering module 14 compares the second rate of speed 120b with the predefined rate of change 30 to determine whether to adjust or alter the steering ratio 20.

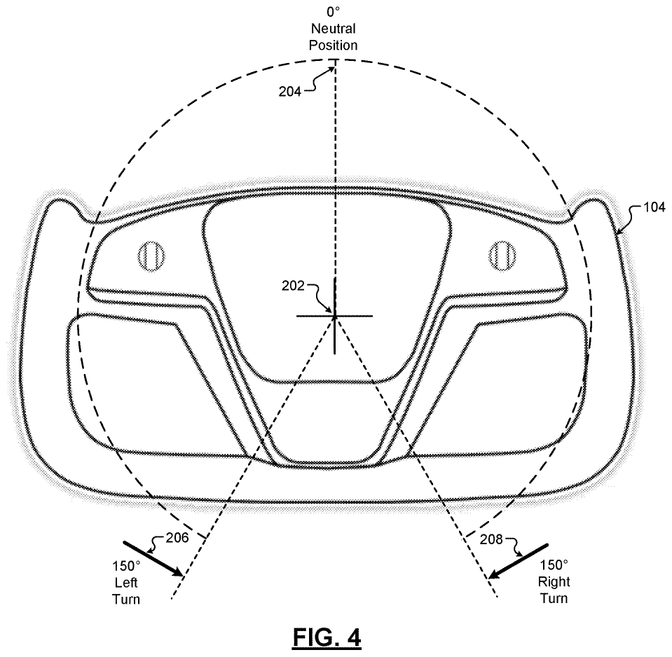

FIG. 4 is a front view of an example yoke steering wheel 104 according to the present disclosure. As shown in FIG. 4, the yoke steering wheel 104 includes grips for the driver to hold the yoke steering wheel 104 at the three o'clock and nine o'clock positions relative to a center 202 of the yoke steering wheel 104. The yoke steering wheel may not include grip portions for the diver at the twelve o'clock and six o'clock positions in some example embodiments.

In various implementations, the yoke steering wheel 104 may have a limited range of rotation compared to full circle wheels (e.g., because it is more difficult or not possible for the driver to execute hand over hand rotations of the yoke steering wheel 104). For example, as shown in FIG. 4, the yoke steering wheel 104 may be configured to turn only 150 degrees to the left to a position 206, form the starting point 204 which is a neutral steering wheel position that will cause the vehicle to travel straight forward in a straight line.

The yoke steering wheel 104 may be configured to turn only 150 degrees to the left to a position 206, form the starting point 204. Although FIG. 4 illustrates a turning range of up to 150 degrees in each direction, other example embodiments may include rotation ranges which are greater than or less than 150 degrees.

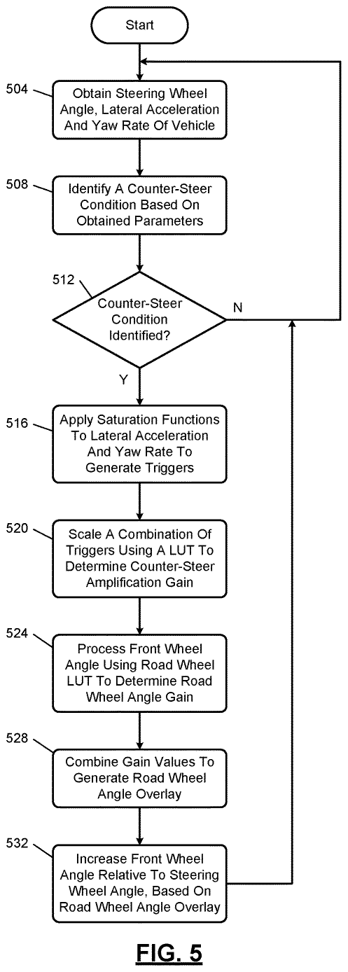

FIG. 5 is a flowchart depicting an example process for automated counter-steer adjustment for steer-by-wire control according to the present disclosure. In some examples, the process of FIG. 5 may be implemented by the vehicle control module 21 of FIG. 1. The process begins at 504, by obtaining a steering wheel angle, a lateral acceleration of the vehicle, and a yaw rate of the vehicle.

At 508, the vehicle control module is configured to identify a counter-steer condition based on the obtained parameters. Control then determines at 512 whether a counter-steer condition has been identified. If not, control returns to 504 to obtain updated parameters of the vehicle.

If control determines at 512 that a counter-steer condition has been identified, control proceeds to 516 to apply saturation functions to the lateral acceleration and yaw rate, to generate triggers. Control then scales a combination of the triggers of at 520, such as by using lookup tables to determine a counter-steer amplification gain.

At 524, the vehicle control module is configured to process the front wheel angle using a road wheel lookup table (LUT), to determine a road wheel angle gain. Control then proceeds to 528 to combine gain values to generate a road wheel angle (RWA) overlay. At 532, the vehicle control module is configured to increase a front wheel angle relative to the steering wheel angle, based on the road wheel angle overlay.

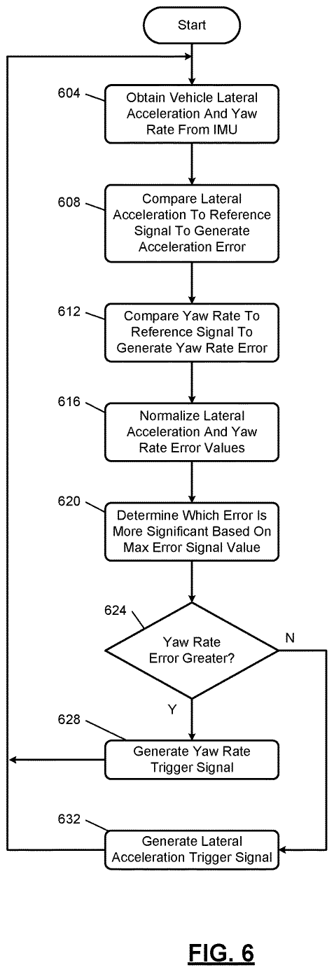

FIG. 6 is a flowchart depicting an example process for determining yaw rate trigger signals and lateral acceleration trigger signals according to the present disclosure. In some examples, the process of FIG. 6 may be implemented by the vehicle control module 21 of FIG. 1. The process begins at 604, by obtaining vehicle lateral acceleration and yaw rate from the inertia measurement unit.

At 608, the vehicle control module is configured to compare the lateral acceleration of the vehicle to a reference signal, to generate an acceleration error value. Control then compares the yaw rate to a reference signal at 612, to generate a yaw rate error value.

At 616, the vehicle control module is configured to normalize the lateral acceleration value and yaw rate error value, such as on a scale of zero to one. At 620, the vehicle control module is configured to determine which error is more significant based on the maximum error signal value. For example, control may determine whether the lateral acceleration error value or the yaw rate error value has a greater value.

If the vehicle control module determines at 624 that the yaw rate error is greater, control proceeds to 628 to generate a yaw rate trigger signal. If control determines the 624 that the yaw rate error is not greater than the lateral acceleration error, control proceeds to 632 to generate a lateral acceleration trigger signal.

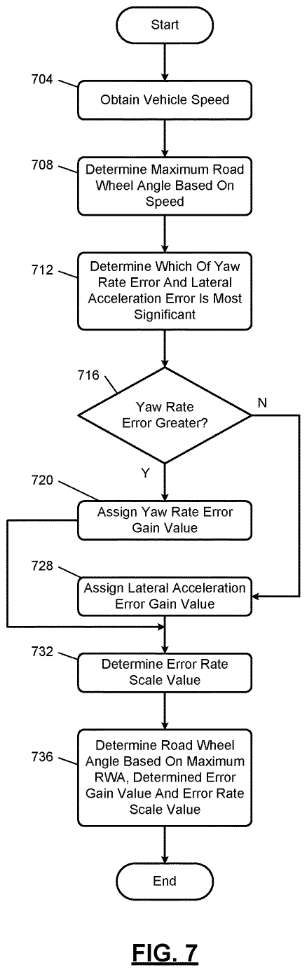

FIG. 7 is a flowchart depicting an example process for determining a road wheel angle value according to the present disclosure. In some examples, the process of FIG. 7 may be implemented by the vehicle control module 21 of FIG. 1. The process begins at 704, by obtaining a vehicle speed.

At 708, the vehicle control module is configured to determine the maximum road wheel angle based on the vehicle speed. Control then proceeds to 712 to determine which of the yaw rate error and the lateral acceleration error is the most significant.

If control determines at 716 that the yaw rate error is greater, control proceeds to 722 to assign an error gain value. If control determines at 716 that the yaw rate error is not greater, control proceeds to 728 to assign a lateral acceleration error value. Control then determines an error rate scale value at 732, and proceeds to 736 to determine the road wheel angle. The road wheel angle may be determined based on, for example, the maximum road wheel angle, the determined error gain value, and the error rate scale value.

In some examples, the triggers may indicate whether the vehicle is behaving in a way that the driver does not intend. For example, a reference model may be tuned to predict or simulate how a vehicle would operate during a normal, linear driving condition (e.g., what parameter values may be sensed during normal driving). The reference model may be compared to current vehicle parameters, such as parameters captured via an inertia measurement unit (IMU) which may include accelerometers, gyroscopes, etc.

An overlay may refer to additional road wheel angle that the steer-by-wire control module is going to add to the current steering wheel angle input from the driver. In other words, the overlay may indicate how much to increase steering wheel angle on top of what driver is already doing, based on vehicle speed, how much lateral acceleration and yaw rate error is present, etc. In some examples, both counter-steer detection overlay and error overlay may be added together to determine how much to increase the road wheel angle relative to the steering wheel input, to allow greater wheel rotation to recover from the oversteering condition.

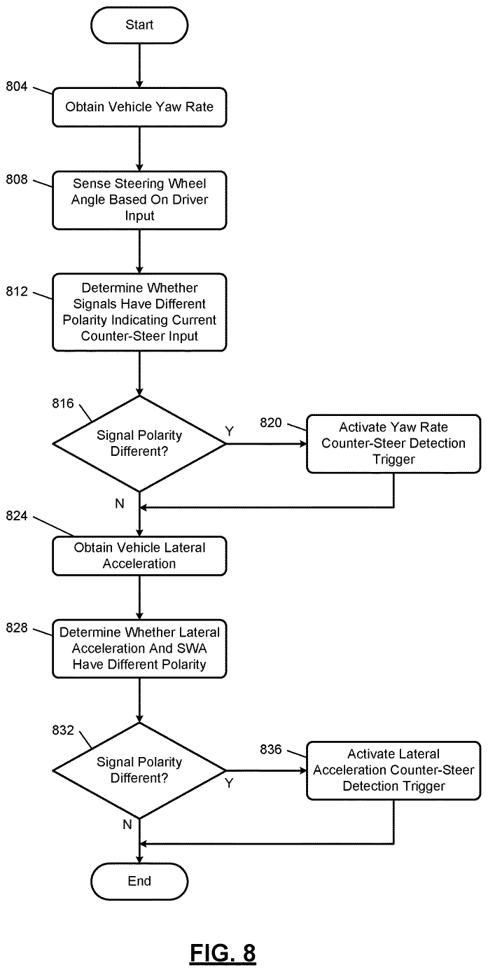

FIG. 8 is a flowchart depicting an example process for activating counter-steer detection triggers according to the present disclosure. In some examples, the process of FIG. 8 may be implemented by the vehicle control module 21 of FIG. 1. The process begins at 804, by obtaining the vehicle yaw rate.

At 808, the vehicle control module is configured to sense a steering wheel angle based on the driver input. Control then proceeds to 812 to determine whether the received sensor signals have different polarity, which may indicate a current counter-steer input from the driver. For example, if the vehicle as yawing in one direction, while the driver is turning the steering wheel in an opposite direction, this may indicate that an oversteer condition has happened and the driver is attempting to recover using a counter-steer technique.

If control determines that the signal polarity is different at 816, control proceeds to 820 to activate the yaw rate counter-steer detection trigger. At 824, the vehicle control module is configured to obtain a vehicle lateral acceleration parameter. Control then determines whether the lateral acceleration and the steering wheel angle have a different polarity, at 828. If the signal polarities are different at 832, control proceeds to 836 to activate the lateral acceleration counter-steer detection trigger.

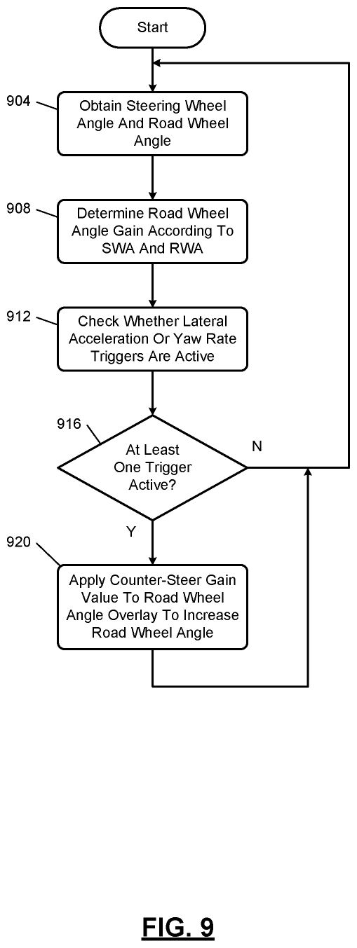

FIG. 9 is a flowchart depicting an example process for applying counter-steer amplification gain values according to the present disclosure. In some examples, the process of FIG. 9 may be implemented by the vehicle control module 21 of FIG. 1. The process begins at 904, by obtaining the steering wheel angle and the road wheel angle of the vehicle.

At 908, the vehicle control module is configured to determine the road wheel angle gain according to the steering wheel angle and the road wheel angle. Control then proceeds to 912 to check whether the lateral acceleration trigger or the yaw rate trigger is active. If at least one trigger is active at 916, control proceeds to 920 to apply a counter-steer gain value to the road wheel angle overlay to increase the road wheel angle.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

1. A vehicle system including automated counter-steer adjustment for steer-by-wire control, the vehicle system comprising:
front wheels of a vehicle;
a steering wheel configured to rotate less than or equal to 150 degrees in each direction from a neutral steering wheel position;
a steer-by-wire link between the steering wheel and the front wheels of the vehicle, the steer-by-wire link configured to adjust a wheel angle of the front wheels in response to rotation of the steering wheel;
a steering wheel position sensor configured to detect a steering wheel angle of the steering wheel;
an inertia measurement unit configured to detect a lateral acceleration of the vehicle and a yaw rate of the vehicle; and
a vehicle control module configured to:
obtain the steering wheel angle of the steering wheel, the lateral acceleration of the vehicle, and the yaw rate of the vehicle;
identify a counter-steer condition based on the steering wheel angle, the lateral acceleration and the yaw rate, wherein the counter-steer condition is indicative of the steering wheel angle having an opposite polarity to the yaw rate;
in response to identifying the counter-steer condition, determine a counter-steer amplification gain by,
applying a first saturation function to the lateral acceleration to generate a lateral acceleration trigger,
applying a second saturation function to the yaw rate to generate a yaw rate trigger, and
determining the counter-steer amplification gain according to the lateral acceleration trigger and the yaw rate trigger; and
apply the counter-steer amplification gain to the steer-by-wire link to increase the wheel angle of the front wheels relative to the steering wheel angle.

2. The vehicle system of claim 1, wherein the steering wheel comprises a yoke steering wheel having hand grip portions at three o'clock and nine o'clock positions relative to a center of the yoke steering wheel.

3. The vehicle system of claim 2, wherein the yoke steering wheel does not include hand grip positions at twelve o'clock and six o'clock positions relative to the center of the yoke steering wheel.

4. (canceled)

5. The vehicle system of claim 1, wherein the vehicle control module is configured to determine the counter-steer amplification gain by:
combining the lateral acceleration trigger and the yaw rate trigger; and
scaling a combination of the lateral acceleration trigger and the yaw rate trigger using a lookup table to determine the counter-steer amplification gain.

6. The vehicle system of claim 5, wherein the vehicle control module is configured to:
obtain the wheel angle of the front wheels; and
process the wheel angle of the front wheels using a road wheel angle lookup table to determine a road wheel angle gain.

7. The vehicle system of claim 6, wherein the vehicle control module is configured to:
combine the counter-steer amplification gain and the road wheel angle gain to generate a road wheel angle overlay; and
increase the wheel angle of the front wheels relative to the steering wheel angle, according to the road wheel angle overlay, to facilitate increased counter-steer of the front wheels of the vehicle.

8. The vehicle system of claim 7, wherein the vehicle control module is configured to:
access a reference model tuned to predict vehicle parameters for a baseline driving condition;
obtain current vehicle parameters according to a current driving condition of the vehicle;
compare the current vehicle parameters to the reference model; and
identify the counter-steer condition according to a difference between the current vehicle parameters and the reference model exceeding a specified counter-steer threshold.

9. The vehicle system of claim 8, wherein the vehicle control module is configured to:
determine an error overlay based on the difference between the current vehicle parameters and the reference model; and
adjust the steering wheel angle according to the error overlay.

10. The vehicle system of claim 1, wherein the inertia measurement unit includes at least one of an accelerometer or a gyroscope.

11. A method of automatically adjusting counter-steer for steer-by-wire control of a vehicle, the method comprising:
obtaining, from a steering wheel position sensor, a steering wheel angle of a steering wheel of the vehicle, wherein the steering wheel is configured to rotate less than or equal to 150 degrees in each direction from a neutral steering wheel position;
obtaining a lateral acceleration of the vehicle, and a yaw rate of the vehicle, from an inertia measurement unit;
identifying a counter-steer condition based on the steering wheel angle, the lateral acceleration and the yaw rate, wherein the counter-steer condition is indicative of the steering wheel angle having an opposite polarity to the yaw rate;
in response to identifying the counter-steer condition, determining a counter-steer amplification gain by,
applying a first saturation function to the lateral acceleration to generate a lateral acceleration trigger,
applying a second saturation function to the yaw rate to generate a yaw rate trigger, and
determining the counter-steer amplification gain according to the lateral acceleration trigger and the yaw rate trigger; and
applying the counter-steer amplification gain to a steer-by-wire link to increase a wheel angle of front wheels of the vehicle relative to the steering wheel angle, wherein the steer-by-wire link is configured to adjust the wheel angle of the front wheels in response to rotation of the steering wheel.

12. The method of claim 11, wherein the steering wheel comprises a yoke steering wheel having hand grip portions at three o'clock and nine o'clock positions relative to a center of the yoke steering wheel.

13. The method of claim 12, wherein the yoke steering wheel does not include hand grip positions at twelve o'clock and six o'clock positions relative to the center of the yoke steering wheel.

14. (canceled)

15. The method of claim 11, wherein determining the counter-steer amplification gain includes:
combining the lateral acceleration trigger and the yaw rate trigger; and
scaling a combination of the lateral acceleration trigger and the yaw rate trigger using a lookup table to determine the counter-steer amplification gain.

16. The method of claim 15, further comprising:
obtaining the wheel angle of the front wheels; and
processing the wheel angle of the front wheels using a road wheel angle lookup table to determine a road wheel angle gain.

17. The method of claim 16, further comprising:
combining the counter-steer amplification gain and the road wheel angle gain to generate a road wheel angle overlay; and
increasing the wheel angle of the front wheels relative to the steering wheel angle, according to the road wheel angle overlay, to facilitate increased counter-steer of the front wheels of the vehicle.

18. The method of claim 17, further comprising:
accessing a reference model tuned to predict vehicle parameters for a baseline driving condition;
obtaining current vehicle parameters according to a current driving condition of the vehicle;
comparing the current vehicle parameters to the reference model; and
identifying the counter-steer condition according to a difference between the current vehicle parameters and the reference model exceeding a specified counter-steer threshold.

19. The method of claim 18, further comprising:
determining an error overlay based on the difference between the current vehicle parameters and the reference model; and
adjusting the steering wheel angle according to the error overlay.

20. A vehicle system including automated counter-steer adjustment for steer-by-wire control, the vehicle system comprising:
front wheels of a vehicle;
a yoke steering wheel configured to rotate less than or equal to 150 degrees in each direction from a neutral steering wheel position;
a steer-by-wire link between the yoke steering wheel and the front wheels of the vehicle, the steer-by-wire link configured to adjust a wheel angle of the front wheels in response to rotation of the yoke steering wheel; and
a vehicle control module configured to:
obtain a steering wheel angle of the yoke steering wheel, a lateral acceleration of the vehicle, and a yaw rate of the vehicle, from one or more vehicle sensors;
identify a counter-steer condition based on the steering wheel angle, the lateral acceleration and the yaw rate, wherein the counter-steer condition is indicative of the steering wheel angle having an opposite polarity to the yaw rate;
in response to identifying the counter-steer condition, determine a counter-steer amplification gain by,
applying a first saturation function to the lateral acceleration to generate a lateral acceleration trigger,
applying a second saturation function to the yaw rate to generate a yaw rate trigger, and
determining the counter-steer amplification gain according to the lateral acceleration trigger and the yaw rate trigger; and
apply the counter-steer amplification gain to the steer-by-wire link to increase the wheel angle of the front wheels relative to the steering wheel angle.
